(19) United States
(12) Patent Application Publication
(10) Pub. No.: US 2010/0212319 A1
(43) Pub. Date: Aug. 26, 2010

(54) Method and apparatus for generating power utilizing forward osmosis

(76) Inventor: Mark Donovan, Aliso Viejo, CA (US)

Correspondence Address: MARK DONOVAN, 46 SENTINEL PLACE, ALISO VIEJO, CA, 92656, US

(21) Appl. No.: 12/660,274

(22) Filed: Feb. 24, 2010

Related U.S. Application Data
(60) Provisional application No. 61/208,298, filed on Feb. 24, 2009.

(51) Int. Cl. F03G 7/04; H02K 7/18; F01K 25/06

(52) U.S. Cl. 60/649; 290/52; 60/673

(57) ABSTRACT

A method and apparatus are described for generating power. A first liquid comprising brine from a seawater reverse osmosis desalination process is provided on one side of a semipermeable membrane. This liquid has an osmotic pressure greater than seawater. A second liquid having an osmotic pressure less than seawater is provided on a second side of the membrane. A hydraulic pressure is provided to the first liquid that is less than the osmotic pressure difference between the first liquid and the second liquid so that some of the second liquid flows through the membrane and combines with the first liquid at a lesser rate than would occur without the hydraulic pressure thereby increasing the potential energy in the combined first and second liquids. The combined first and second liquids are delivered to a turbine thereby converting the increased potential energy into useful mechanical energy.

### CROSS REFERENCE TO RELATED APPLICATIONS

This application claims the benefit of provisional patent application No. 61/208,298 filed 2009 Feb. 24 by the present inventor.

### BACKGROUND

### Prior Art

The following is a tabulation of some prior art that presently appears relevant:

U.S. Patents

| Patent Number | Kind Code | Issue Date | Patentee |
|---|---|---|---|
| U.S. Pat. No. 3,906,250 | | Sep. 16, 1975 | Sidney Loeb |

World Intellectual Property Organization Document

| Patent Number | Kind Code | Issue Date | App orPatentee |
|---|---|---|---|
| WO 02/13,955 A1 | | Feb. 21, 2002 | Thorsen, Thor |
| | | | Holt, Torleif |

### DESCRIPTION

The global need for renewable, clean energy is at an all time high. The current practice of burning fossil fuels for energy has been shown to have extremely negative environmental affects, and is responsible for the release of carbon dioxide into the atmosphere which is strongly linked to global climate change. One such form of clean, renewable energy is osmotic energy. Osmotic energy utilizes the osmotic pressure difference between two liquids to create a hydrostatic pressure that can be converted to useful energy such as generating electricity.

U.S. Pat. No. 3,906,250, which is hereby incorporated by reference in its entirety, describes a method and apparatus for generating power by utilizing pressure-retarded-osmosis, or more commonly known today as forward osmosis. As described in U.S. Pat. No. 3,906,250 generating power by forward osmosis is accomplished as follows: A first liquid having a relatively high osmotic pressure is introduced at a relatively high hydraulic pressure into a first pathway in which it contacts one face of semi-permeable membrane, and a second liquid having a lower osmotic pressure is introduced at a lower hydraulic pressure into a second pathway in which it contacts the opposite face of the membrane. At every point in the two pathways, the hydraulic pressure difference between the two liquids on the opposite faces of the membrane is maintained at a value which is less than the osmotic pressure difference between the liquids. Part of the second liquid passes by forward osmosis through the semipermeable membrane, forming a pressurized mixed solution of greater volume than that of the first liquid introduced into the first pathway. The potential energy stored in the pressurized mixed solution is then converted into useful energy, such as electrical or mechanical power.

U.S. Pat. No. 3,906,250 goes on to describe several examples of two such liquids with different osmotic pressures, such as seawater and river water, or brine solutions from evaporation ponds and river water. While technically feasible, this patent was never brought to commercialization because it was cost prohibitive.

International Patent WO 02/13955 A1, which is hereby incorporated by reference in its entirety, improved on U.S. Pat. No. 3,906,250 by increasing the overall efficiency of the system by incorporating the use of an isobaric energy recovery device. However, this patent still makes reference to the use of seawater and river water as the two liquid solutions with different osmotic pressures.

### SUMMARY

The current embodiment improves on the aforementioned U.S. Pat. No. 3,906,250 in three ways:
The first improvement specifically uses the brine stream (or also called concentrate stream, or reject stream) from a seawater desalination plant as the high osmotic pressure liquid and uses treated wastewater as the low osmotic pressure liquid. The brine stream can be from either a thermal desalination plant or from a seawater reverse osmosis desalination plant. The brine stream from a seawater desalination plant has a higher osmotic pressure than seawater and more electricity can be generated per unit volume, making this process more efficient than the one utilizing seawater as the high osmotic pressure liquid.
The second improvement uses an isobaric energy recovery device to increase the efficiency of the overall system. The use of such a device is also found in International Patent WO 02/13955 A1. Alternatively, the apparatus could be direct coupled to a seawater reverse osmosis desalination facility and used as an energy recovery device.
The third improvement uses treated wastewater instead of river water as the low osmotic pressure liquid. The use of treated wastewater does not compete for local drinking water sources, as the use of river water does. This is especially significant in dry regions or in areas experiencing drought.

### Advantages

There are significant economic and environmental benefits to utilizing two streams that are normally considered waste streams and using them in a beneficial manner to create clean, renewable energy. As part of the seawater desalination process for turning seawater into drinking water, a concentrated brine stream is generated that is typically returned to the ocean. Additionally, large volumes of treated municipal and industrial wastewater are routinely discharged into the ocean. This embodiment utilizes these two “waste” streams to generate clean, sustainable energy, and then returns the streams to the ocean. Additionally, by using the brine stream with a much higher salt concentration than seawater, as the high osmotic pressure liquid, the overall process becomes much more efficient and is able to generate more electricity per volume of water used. When constructed in conjunction with a seawater desalination plant, the electricity generated can be used to offset the high amount of electricity consumed by the desalination plant, increasing the desalination plant's energy efficiency and reducing the desalination plant's overall carbon footprint.

Also, by using treated wastewater as the low osmotic pressure liquid instead of river water, we are not competing for local drinking water sources, as is the case when river water is used as the lower osmotic pressure liquid.

Incorporating an isobaric energy recovery device into the design also increases the overall efficiency of the osmotic energy process. This high efficiency device allows for lower pumping energy requirements for the brine stream, increasing the net energy output of the entire system. Other advantages of one of more aspects will be apparent from a consideration of the drawings and ensuing description.

### DRAWINGS

### Figures

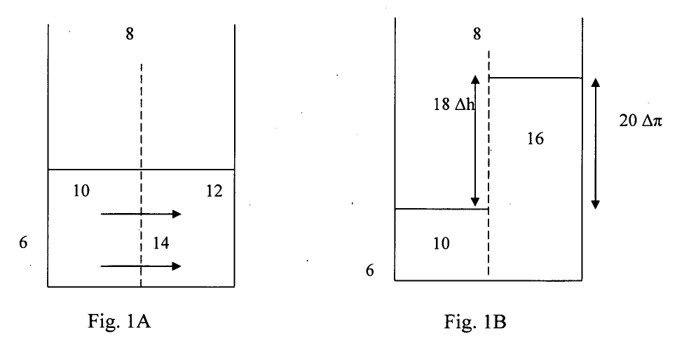

FIGS. 1a and b describe the natural phenomenon of forward osmosis across a semi-permeable membrane.

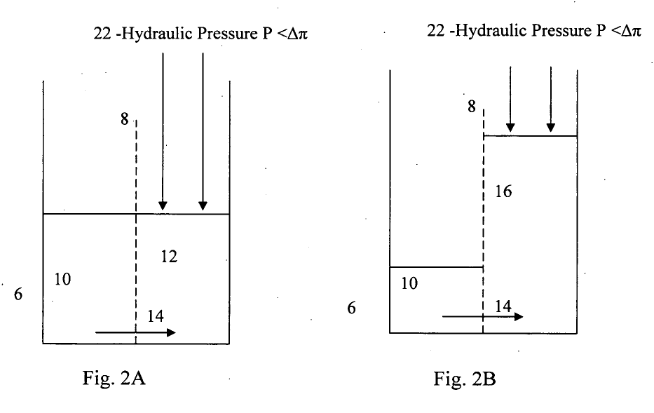

FIGS. 2a and 2b describe the application of hydraulic pressure to the brine which is less than the osmotic pressure of the brine solution.

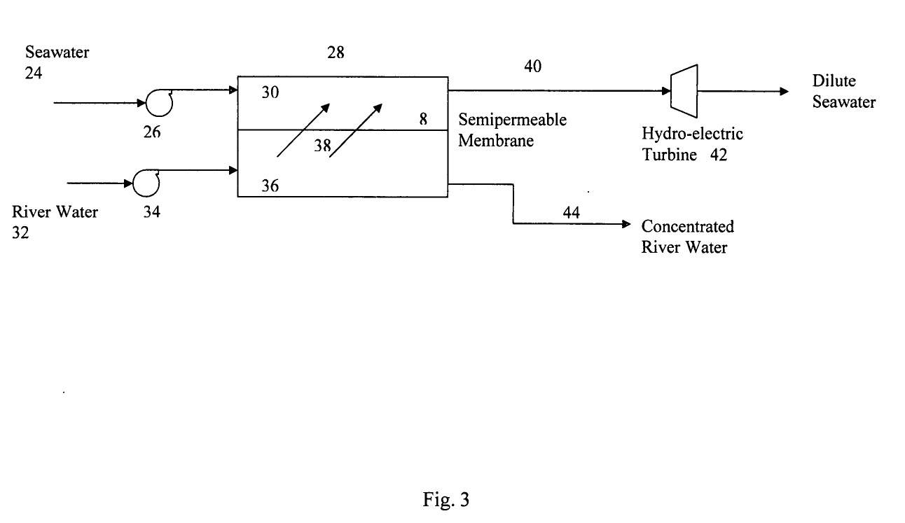

FIG. 3 describes the original PRO process for the production of energy as presented by Loeb.

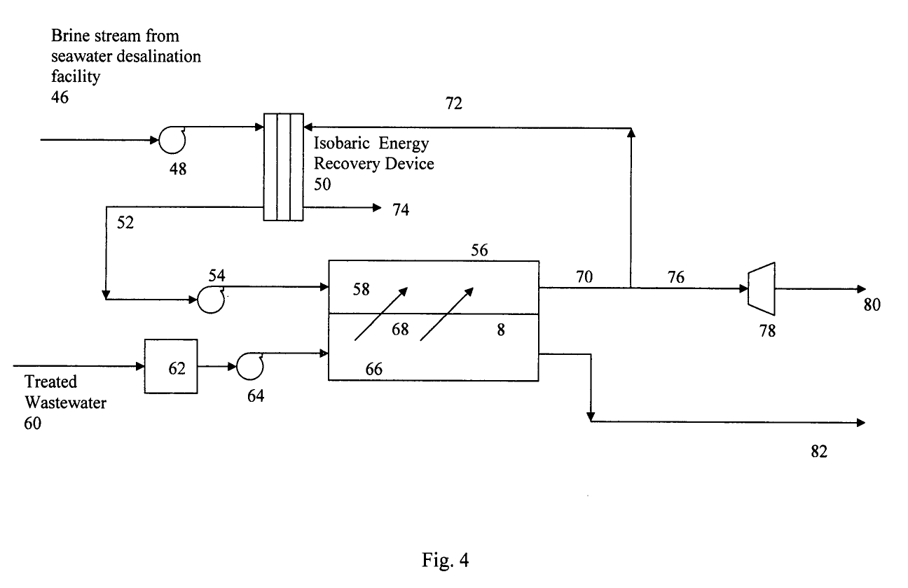

FIG. 4 describes the improved osmotic energy process.

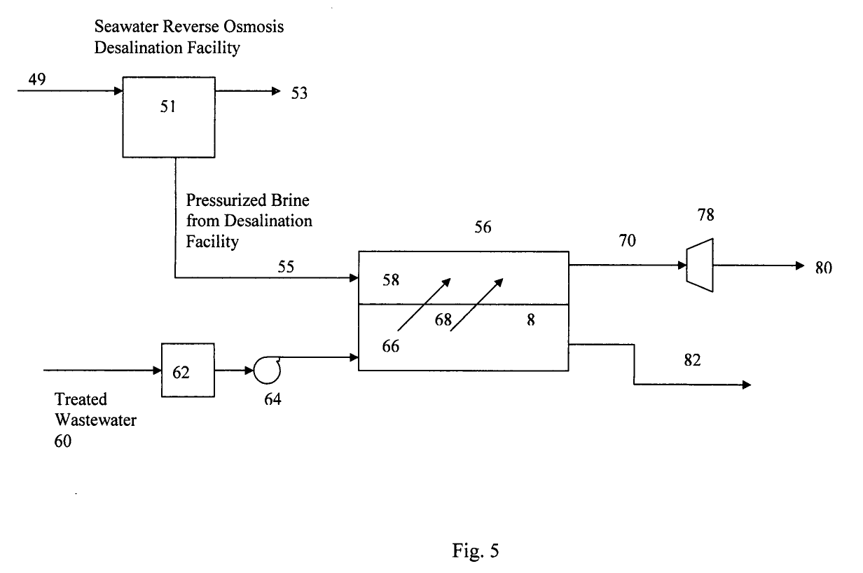

FIG. 5 describes the osmotic energy process direct-coupled to a seawater reverse osmosis system and used as an energy recovery device.

Drawings - Reference Numerals

| | |
|---|---|
| 6) Vessel | 8) Semi-permeable membrane |
| 10) Dilute Solution | 12) Concentrated Solution |
| 14) Flow of water through membrane | 16) Less concentrated solution |
| 18) Hydrostatic pressure differential | 20) Osmotic pressure differential |
| 22) Applied hydraulic pressure | 24) Seawater |
| 26) High pressure pump | 28) Forward osmosis apparatus |
| 30) High pressure flow pathway | 32) River water |
| 34) Low pressure pump | 36) Low pressure flow pathway |
| 38) Flow of water through membrane | 40) Less concentrated high pressure |
| | seawater stream |
| 42) Hydroelectric turbine | 44) Concentrated river water exit stream |
| 46) Brine from seawater desalination | 48) Low pressure brine pump |
| facility | |
| 49) Seawater | 50) Isobaric Energy Recovery Device |
| 51) Seawater Reverse Osmosis | 52) Pressurized brine stream |
| Desalination Facility | |
| 53) Drinking Water | 55) Pressurized Brine from Desalination |
| | Facility |
| 54) High pressure booster pump | 56) Forward osmosis apparatus |
| 58) High pressure flow pathway | 60) Treated wastewater |
| 62) Pretreatment step | 64) Low pressure wastewater pump |
| 66) Low pressure flow pathway | 68) Flow of water through membrane |
| 70) Less concentrated high pressure brine | 72) High pressure stream to Isobaric |
| | Energy Recovery Device |
| 74) Low pressure stream exit from Isobaric | 76) High pressure stream to hydroelectric |
| Energy Recovery Device | turbine |
| 78) Hydroelectric turbine | 80) Hydroelectric turbine exit stream |
| 82) Concentrated wastewater exit stream | |

### DETAILED DESCRIPTION

### FIGS. 1-5

FIGS. 1a and 1b illustrate the basic concept of osmosis, also known as forward osmosis. In FIG. 1a there is a vessel 6 divided into two chambers 10, 12 by a semi-permeable membrane 8. This semipermeable membrane 8 allows water to flow through it, but ideally does not allow any dissolved salts to pass through. Chamber 10 contains a dilute solution such as treated wastewater with a very low osmotic pressure of approximately 5-10 psi. Chamber 12 contains a concentrated solution such as brine from a seawater desalination plant with a much higher osmotic pressure of approximately 685 psi. Water will start to flow 14 from the dilute solution side 10 through the semipermeable membrane 8 to the concentrated solution side 12 in an effort to create equilibrium of chemical potential on both sides of the membrane. The flux of water 14 is given by Equation 1:

J=AΔπ Equation 1

J is the flux of water (i.e. flow rate per area of membrane)
Δπ is the difference in osmotic pressure across the membrane
A is a constant which depends on membrane properties.

Over time, as water flows through the membrane 8 to the concentrated side, the water level in that chamber increases. FIG. 1b shows that when equilibrium is reached the water will stop flowing. Equilibrium is reached when the hydrostatic pressure differential Δh 18 between the two liquids, which is a result from the changes in volume, equals the osmotic pressure differential Δπ 20 of the dilute solution 10 and the now less concentrated solution 16.

FIGS. 2a and 2b illustrate the case of applying a hydraulic pressure to the concentrated solution, which is the basis for generating power via forward osmosis. FIG. 2a shows how a hydraulic pressure P 22, less than the osmotic pressure differential of the concentrated solution and dilute solution is applied to the concentrated solution 12. Water will still flow 14 from the dilute side to the concentrated side against the hydraulic pressure, albeit at a different rate. The new rate of flux is given by Equation 2:

J′=A(Δπ−P) Equation 2

FIG. 2b shows that as the process continues, the volume of water 16 under pressure P has increased, and volume of water on the dilute side 10 has decreased by the amount of water that flowed through the membrane 8, ΔV. This higher volume of water (V+ΔV) under the applied hydraulic pressure 16 now has the potential for delivering energy by passage through a hydroelectric turbine. The energy delivered by the hydroelectric turbine is greater than the energy used to apply the hydraulic pressure to the concentrated solution.

FIG. 3 shows the continuous process of generating electricity via forward osmosis as described by Loeb. First, the hydraulic pressure of seawater 24 is raised by pump 26 and delivered to the general forward osmosis apparatus 28. The pressurized seawater is introduced into flow pathway 30, which defines one side of the semipermeable membrane 8. River water 32 is delivered at very low hydraulic pressure via pump 34 to the general forward osmosis apparatus 28, specifically into flow pathway 36, which defines the other side of the semipermeable membrane 8. A portion of the river water flows 38 through the semipermeable membrane 8 into flow pathway 30, increasing the volume of pressurized water in flow pathway 30. The pressurized, higher volume, less concentrated seawater stream 40 is then sent to the hydroelectric turbine 42. The remaining portion of river water 44 that did not permeate through the membrane exits the apparatus. The hydroelectric turbine generates more electricity than was used to deliver both the seawater and river water to the apparatus, thus delivering a net positive amount of electrical energy.

FIG. 4 shows the improved, more advanced and efficient process for generating power via forward osmosis with the brine from a seawater desalination facility and treated wastewater and incorporating the use of an isobaric energy recovery device. Brine from a seawater desalination facility 46 is delivered to an isobaric energy recovery device 50 at low hydraulic pressure by means of pump 48. The isobaric energy recovery device 50 transfers the energy from the stream with high hydraulic pressure 72 to the incoming brine stream and boosts the hydraulic pressure of the brine stream significantly 52. The pressurized brine stream then enters pump 54 where the pressure is boosted a small amount to the desired feed pressure to the forward osmosis apparatus 56. The high pressure brine stream is introduced into flow pathway 58, which defines one side of the semipermeable membrane 8. Treated wastewater 60 is delivered at very low hydraulic pressure via pump 64 to the forward osmosis apparatus 56, specifically into flow pathway 66 which defines the other side of the semipermeable membrane 8. Depending on the nature of the treated wastewater, a pretreatment step 62 may be necessary to further treat the wastewater prior to entering the forward osmosis apparatus 56. Once the treated wastewater is introduced into flow pathway 66, a portion of the treated wastewater flows 68 through the semipermeable membrane 8 into flow pathway 58, increasing the volume of high pressure water in flow pathway 58. The pressurized, higher volume, less concentrated brine stream exits the forward osmosis apparatus via stream 70. A portion of this pressurized stream is sent to the isobaric energy recovery device 50 via stream 72, where the energy in stream 72 is transferred to the incoming brine stream 46 to increase the hydraulic pressure of the incoming brine stream as mentioned previously. Once the energy has been transferred from stream 72 to the brine, the now low pressure liquid from stream 72 exits the isobaric energy recovery device via stream 74. The remaining volume of high pressure liquid from stream 70 is sent to the hydroelectric turbine 78 via stream 76. The remaining portion of the treated wastewater that did not permeate through the membrane 8 exits the forward osmosis apparatus via stream 82. The hydroelectric turbine generates more electricity than was used to deliver both the brine and treated wastewater to the apparatus, delivering a net positive amount of clean, renewable electricity. It is important to note that the feed pressure to the forward osmosis apparatus must be less than the osmotic pressure differential between stream 70 and 82.

FIG. 5 shows the forward osmosis apparatus direct-coupled to a seawater reverse osmosis desalination facility and utilized as an energy recovery device. A seawater reverse osmosis desalination facility 51 takes in seawater 49 and turns it into drinking water 53, with a concentrated brine stream as the byproduct of this process. The seawater reverse osmosis desalination facility may or may not be equipped with a mechanical energy recovery device. The seawater reverse osmosis facility is designed, or modified if an existing plant, so that the pressurized brine stream exiting the facility 55 retains the desired pressure to send to the forward osmosis apparatus 56. The high pressure brine stream is introduced into flow pathway 58, which defines one side of the semipermeable membrane 8. Treated wastewater 60 is delivered at very low hydraulic pressure via pump 64 to the forward osmosis apparatus 56, specifically into flow pathway 66 which defines the other side of the semipermeable membrane 8. Depending on the nature of the treated wastewater, a pretreatment step 62 may be necessary to further treat the wastewater prior to entering the forward osmosis apparatus 56. Once the treated wastewater is introduced into flow pathway 66, a portion of the treated wastewater flows 68 through the semipermeable membrane 8 into flow pathway 58, increasing the volume of high pressure water in flow pathway 58. The pressurized, higher volume, less concentrated brine stream exits the forward osmosis apparatus via stream 70. The high volume, high pressure liquid from stream 70 is sent to the hydroelectric turbine 78. The remaining portion of the treated wastewater that did not permeate through the membrane 8 exits the forward osmosis apparatus via stream 82. It is important to note that the feed pressure to the forward osmosis apparatus must be less than the osmotic pressure differential between stream 70 and 82.

### Advantages

From the description above, a number of advantages of some embodiments of my improved osmotic energy process become evident:
(a) The use of brine from a seawater desalination facility instead of seawater as the high osmotic pressure liquid allow for a higher feed pressure to the hydroelectric turbine, and thus more electricity is generated per unit volume of water. In the original process described by Loeb, a system using approximately 20 million gallons a day of seawater and 20 million gallons of river water would generate approximately 0.5 MW of electricity. The method described by Thorsen, with the incorporation of the isobaric energy recovery device and using the same 20 million gallons a day of seawater and 20 million gallons a day of river water, would generate approximately 0.58 MW of electricity. The improved process as described in this embodiment, using 20 million gallons a day of brine from a seawater desalination facility as the high osmotic pressure liquid and 20 million gallons a day treated wastewater as the low osmotic pressure liquid, would generate approximately 1.8 MW of clean, renewable electricity. This is over 3.5 times as much electricity as the process described by Loeb and over 3 times as much as electricity as the process described by Thorsen.
(b) Another advantage stems from the use of treated wastewater instead of river water as the low osmotic pressure liquid. In certain areas of the country, and the world, fresh drinking water is becoming more and more scarce. River water is an essential form of drinking water that often cannot be used for industrial process such as generating electricity.
(c) There are considerable economic and environmental advantages to using two streams normally considered waste streams in a beneficial manner such as generating clean, renewable electricity. Infrastructure and civil works costs of the osmotic energy facility are dramatically lowered, since the two streams used in the facility are already available from other nearby man-made facilities. The brine from the seawater desalination facility and treated wastewater from the wastewater treatment plant are simply delivered via pipeline. The additional complex infrastructure needed to obtain new seawater and new river water is not necessary.

### CONCLUSION, RAMIFICATIONS, AND SCOPE

Accordingly, the reader will see that there are many advantages to using this method to generate renewable energy and also to recover energy from a reverse osmosis process. The descriptions listed thus far should not be construed as limiting the scope of the embodiments but merely as providing illustrations of some of several embodiments. Thus the scope of the embodiments should be determined by the appended claims and their legal equivalents, rather than by the examples given.

What is claimed is:

1. A method of generating power comprising:
Providing a semipermeable membrane;
Providing a flow of a first liquid on a first side of the membrane having an osmotic pressure greater than seawater, wherein the first liquid comprises brine from a seawater reverse osmosis desalination process;
Providing a flow of a second liquid on a second side of the membrane having an osmotic pressure less than seawater;
Providing a hydraulic pressure to the first liquid that is less than the osmotic pressure difference between the first liquid and the second liquid so that some of the second liquid flows through the membrane and combines with the first liquid at a lesser rate than would occur without the hydraulic pressure thereby increasing the potential energy in the combined first and second liquids; and
Delivering the combined first and second liquids to a turbine thereby converting the increased potential energy into useful mechanical energy.

2. The method of claim 1 wherein the second liquid comprises treated wastewater.

3. The method of claim 1 further comprising diverting a portion of the combined first and second liquids to an isobaric energy recovery device thereby transferring the energy in the diverted combined first and second liquids to the flow of the first liquid.

4. The method of claim 3 wherein there is a low pressure exit stream from the isobaric energy recovery device and this low pressure exit stream is combined with the combined first and second liquids that have powered the turbine and with the portion of the second liquid that did not flow through the membrane and this new combination is delivered to the ocean.

5. The method of claim 1 wherein the turbine is a hydroelectric turbine configured to generate electricity.

6. The method of claim 5 wherein the flow of the first liquid and the flow of the second liquid are provided by pumps and some of the electricity generated is used to power the pumps.

7. The method of claim 1 wherein the turbine is used to assist in pumping seawater in the seawater desalination process.

8. The method of claim 1 wherein the combined first and second liquids that have powered the turbine are thereafter combined with the portion of the second liquid that did not flow through the membrane and this new combination is delivered to the ocean.
